(19) United States
(12) Patent Application Publication
(10) Pub. No.: US 2007/0210010 A1
(43) Pub. Date: Sep. 13, 2007

(54) Catalyst for wastewater treatment and method for wastewater treatment using said catalyst

(75) Inventors: Junichi Miyake, Akashi-shi (JP); Tohru Ishii, Ibo-gun (JP)

Correspondence Address: BUCHANAN, INGERSOLL & ROONEY PC, POST OFFICE BOX 1404, ALEXANDRIA, VA, 22313-1404, US

(73) Assignee: NIPPON SHOKUBAI CO., LTD., Osaka (JP)

(21) Appl. No.: 11/681,208

(22) Filed: Mar. 2, 2007

(30) Foreign Application Priority Data
Mar. 10, 2006 (JP) 2006-065517

(51) Int. Cl. C02F 1/72

(52) U.S. Cl. 210/762

(57) ABSTRACT

The present invention relates to a catalyst for wastewater treatment and a method for wet oxidation treatment of wastewater using the catalyst, in particular, the catalyst of the present invention can suitably be used in wet oxidation treatment of wastewater, under high temperature and high pressure conditions. The present invention provides a catalyst for wastewater treatment containing a catalytic active constituent containing at least one kind of an element selected from the group consisting of manganese, cobalt, nickel, cerium, tungsten, copper, silver, gold, platinum, palladium, rhodium, ruthenium and iridium, or a compound thereof, and a carrier constituent containing at least one kind of an element selected from the group consisting of iron, titanium, silicon, aluminum and zirconium, or a compound thereof, characterized in that solid acid amount of the carrier constituent is equal to or more than 0.20 mmol/g.

### BACKGROUND OF THE INVENTION

1. Field of the Invention

The present invention relates to a catalyst for wastewater treatment and a method for wet oxidation treatment of waste water using the catalyst. In particular, the catalyst of the present invention can suitably be used in wet oxidation treatment of wastewater, under high-temperature and high-pressure conditions.

2. Description of Related Art

Conventionally, as a method for wastewater treatment, biological treatment, combustion treatment and the Timmerman method have been known.

As a method for biological treatment, an activated sludge method, an aerobic treatment method such as a biological membrane method, an anaerobic treatment method such as a methane fermentation method, and a combination treatment method of an aerobic treatment method and an anaerobic treatment method have conventionally been used. In particular, an aerobic treatment method using a microorganism has widely been adopted as a wastewater treatment method, however, the aerobic microorganism treatment method, where bacteria, algae, protozoan and the like exert complicated interactions each other, had a problem of complicated apparatuses or operations, because dilution or pH adjustment of wastewater is required so as to furnish suitable environment for the growth of microorganisms, in the case where wastewater containing high concentration of organic substances or nitrogen compounds is subjected to the aerobic microorganisms treatment method, and also required for further treatment of surplus sludge generated as the surplus sludge is generated and therefore had a problem of high treatment cost in total,.

The combustion treatment method has a problem of significantly high treatment cost, caused by fuel cost or the like, in the case of treatment of a large quantity of wastewater. In addition, this method could generate secondary pollution caused by exhaust gas or the like by combustion.

In the Timmerman method, wastewater is treated under high temperature and high pressure conditions, in the presence of oxygen-containing gas, however, treatment efficiency thereof was generally low, and further secondary treatment equipment was required.

Recently, in particular, with diversified pollutants contained in wastewater to be treated, and with requirement of obtaining treated water with high quality level, sufficient response thereto could no longer be attained by the above conventional methods.

Accordingly, various methods for wastewater treatments have been proposed, aiming at highly efficient wastewater treatment and obtaining treated water with high quality level. For example, a wet oxidation method using a solid catalyst (hereafter abbreviated as “a method for catalytic wet oxidation treatment”) is noticed because of being capable of providing treated water with high quality level, and also having excellent economic performance. Various catalysts have been proposed to enhance treatment efficiency and treatment capability of such a method for catalytic wet oxidation treatment. For example, JP-A-49-44556 has proposed a catalyst supported a noble metal such as palladium, platinum and the like on a carrier such as alumina, silica-alumina, silica gel, activated carbon or the like. In addition, JP-A-49-94157 has proposed a catalyst containing copper oxide or nickel oxide.

Constituents contained in wastewater, however, is not a single substance in general, and in many cases, a nitrogen compound, a sulfur compound, an organic halide, or the like is contained as well as organic substances: Sufficient treatment of these constituents could not be attained even by using the catalyst for treatment of wastewater containing such various pollutants. In addition, reduction of strength of the catalyst with time generated crushing and pulverization of the catalyst, which incurred a problem of durability, and thus sufficient usefulness was not provided with.

As technology to improve strength of a catalyst, for example, JP-A-58-64188 has proposed a catalyst supported a noble metal such as palladium, platinum or the like, or a heavy metal such as iron, cobalt or the like on a carrier such as spherical or cylindrical titania or zirconia. Any of the catalysts, however, was not sufficient enough in catalytic activity and durability.

Accordingly, it is an object of the present invention to provide a catalyst which maintains catalytic activity and durability for a long period in wet oxidation treatment of wastewater and also has a high mechanical strength, and to provide a method for wet oxidation treatment of wastewater using the catalyst.

The present inventor et al. have found, after intensive study, that the above problems could be attained by a catalyst in which a catalyst carrier and catalytic active constituents contains the specified constituents, and also, solid acid content of the carrier is equal to or more than specified value, and thus completed the present invention.

### SUMMARY OF THE INVENTION

A first aspect of the present invention is a catalyst for wastewater treatment containing a catalytic active constituent containing at least one kind of an element selected from the group consisting of manganese, cobalt, nickel, cerium, tungsten, copper, silver, gold, platinum, palladium, rhodium, ruthenium and iridium, or a compound thereof, and a carrier constituent containing at least one kind of an element selected from the group consisting of iron, titanium, silicon, aluminum and zirconium, and a compound thereof, characterized in that solid acid amount of the carrier constituent is equal to or more than 0.20 mmol/g.

The solid acid amount of the carrier constituent is preferably 0.20 to 1.0 mmol/g. In addition, specific surface area of the catalyst is preferably 20 to 70 m²/g.

A second aspect of the present invention is a method for wastewater treatment characterized in that the wastewater is treated using the above catalyst. Preferably, the treatment for the wastewater is a wet oxidation treatment method.

The catalyst of the present invention is excellent in any of mechanical strength, durability and catalytic activity, and in particular, the catalyst of the present invention is capable of maintaining excellent catalytic activity and durability for a long period in wet oxidation treatment of wastewater. Furthermore, wet oxidation treatment of wastewater using the catalyst of the present invention is capable of providing treated water purified in high level.

### BRIEF EXPLANATION OF THE DRAWINGS

FIG. 1 is one of the embodiments of a treatment apparatus for wet oxidation treatment relevant to the present invention: and

FIG. 2 is one of other embodiments of a treatment apparatus for wet oxidation treatment relevant to the present invention.

### DESCRIPTION OF THE PREFERRED EMBODIMENTS

Catalytic active constituents relevant to the present invention represent constituents having action to enhance oxidation/decomposition reaction rate to substances to be oxidized such as an organic compound, a nitrogen compound, a sulfur compound and the like contained in wastewater (hereafter may be referred to as “activated action”), and such a catalytic active constituent includes at least one kind of an element selected from the group consisting of manganese, cobalt, nickel, cerium, tungsten, copper, silver, gold, platinum, palladium, rhodium, ruthenium and iridium, or a compound thereof.

As the above catalytic active constituent, at least one kind of an element selected from the group consisting of manganese, cobalt, nickel, cerium, tungsten, copper, silver, gold, platinum, palladium, rhodium, ruthenium and iridium, or a compound thereof is included; and preferably at least one kind of an element selected from the group consisting of manganese, cerium, gold, platinum, palladium, rhodium, ruthenium and iridium, or a compound thereof; and a more preferable catalytic active constituent includes at least one kind of an element selected from the group consisting of manganese, platinum, palladium and ruthenium, or a compound thereof. A catalyst containing these catalytic active constituents is preferable because of exerting particularly excellent activated action in wet oxidation of wastewater.

The catalytic active constituent is not especially limited as long as being one selected from the above catalytic active constituents, however, preferably includes a water-soluble compound, for example, an inorganic compound such as a halide, a nitrate salt, a nitrite salt, an oxide, a hydroxide, ammonium salt, a carbonate salt or the like; or an organic compound such as an acetate salt, an oxalate salt or the like; and more preferably includes a water-soluble inorganic compound. In addition, the catalytic active constituent may also be an emulsion type, slurry or colloid-like compound, and a suitable compound may be used, as appropriate, depending on a preparation method for a catalyst or a kind of a carrier.

For example, in the case where platinum is used as a catalytic active constituent, platinum black, platinum oxide, platinous chloride, platinic chloride, chloroplatinic acid, sodium chloroplatinate, platinum potassium nitrite, dinitrodiammine platinum, hexaammine platinum, hexahydroxyplatinic acid, cis-dichlorodiammine palatinum, tetraammine platinum dichloride, tetraammine palatinum hydroxide, hexaammine palatinum hydroxide, potassium tetrachloroplatinate or the like may be used.

In addition, in the case where palladium is used as a catalytic active constituent, for example, palladium chloride, palladium nitrate, dinitrodiammine palladium, dichlorodiammine palladium, tetraammine palladium dichloride, cis-dichlorodiammine palladium, palladium black, palladium oxide, tetraammine palladium hydroxide or the like maybe used. In addition, in the case where ruthenium is used as a catalytic active constituent, for example, ruthenium chloride, ruthenium nitrate, hexacarbonyl-u-chlorodichloro diruthenium, ruthenium oxide, dodecacarbonitrile triruthenium, ruthenium acetate, potassium ruthenate or the like may be used.

Furthermore, in the case where manganese is used as a catalytic active constituent, for example, manganese nitrate, manganese acetate, potassium permanganate, manganese dioxide, manganese chloride, manganese carbonate or the like may be used. In addition, in the case where gold is used as a catalytic active constituent, for example, chloroauric acid, potassium tetracyanoaurate (III), potassium dicyanoaurate (I) or the like may be used.

In the present invention, a carrier which supports the catalytic active constituent is a compound containing at least one kind of an element selected from the group consisting of iron, titanium, silicon, aluminum and zirconium, and desirably the carrier has specified solid acid amount as will be described later. As the carrier, an oxide containing at least one kind, or a composite oxide containing at least 2 kinds selected from the group consisting of iron, titanium, silicon, aluminum and zirconium is exemplified. In particular, the carrier constituent is a titanium oxide, or a mixture or a composite oxide between titanium oxide and an oxide of at least one kind of a metal selected from the group consisting of zirconium, iron, silicon and aluminum, preferably, a titanium oxide, or a mixture or a composite oxide between titanium oxide and an oxide of at least one kind of a metal selected from the group consisting of zirconium and iron. In particular, the carrier is recommended to contain at least titanium or zirconium; and as the more preferable carrier, titania or one containing a mixed oxide or a composite oxide containing titania, (for example, TiO₂—ZrO₂, TiO₂—Fe₂O₃, TiO₂—SiO₂, TiO₂—Al₂O₃ or the like), is also desirable, in view of mechanical strength and durability of the catalyst.

As combinations of the catalytic active constituent and the carrier, Pt—TiO₂, Pd—TiO₂, Ru—TiO₂, Pt—Pd—TiO₂, Pt—Rh—TiO₂, Pt—Ir—TiO₂, Pt—Au—TiO₂, Pt—Ru—TiO₂, Pd—Rh—TiO₂, Pd—Ir—TiO₂, Pd—Au—TiO₂, Pd—Ru—TiO₂, MnO₂—TiO₂, Pt—MnO₂—TiO₂, Pd—MnO₂—TiO₂, Pt—Pd—MnO₂—TiO₂, Pt—MnO₂—CeO₂—TiO₂, Pt—CeO₂—TiO₂, Pd—CeO₂—TiO₂, Ru—CeO₂—TiO₂, Pt—TiO₂—ZrO₂, Pd—TiO₂—ZrO₂, Ru—TiO₂—ZrO₂, Pt—Pd—TiO₂—ZrO₂, Pt—Rh—TiO₂—ZrO₂, Pt—Ir—TiO₂—ZrO₂, Pt—Au—TiO₂—ZrO₂, Pt—Ru—TiO₂—ZrO₂, Pd—Rh—TiO₂—ZrO₂, Pd—Ir—TiO₂—ZrO₂, Pd—Au—TiO₂—ZrO₂, Pd—Ru—TiO₂—ZrO₂, MnO₂—TiO₂—ZrO₂, Pt—MnO₂—TiO₂—ZrO₂, Pd—MnO₂—TiO₂—ZrO₂, Pt—Pd—MnO₂—TiO₂—ZrO₂, Pt—MnO₂—CeO₂—TiO₂—ZrO₂, Pd—MnO₂—CeO₂—TiO₂—ZrO₂, Pt—CeO₂—TiO₂—ZrO₂, Pd—CeO₂—TiO₂—ZrO₂, Ru—CeO₂—TiO₂—ZrO₂, Pt—Fe₂O₃—TiO₂, Pd—Fe₂O₃—TiO₂, Rn—Fe₂O₃—TiO₂, Pt—Pd—Fe₂O₃—TiO₂, Pt—Pd—Fe₂O₃—TiO₂, Pt—Ir—Fe₂O₃—TiO₂, Pt—Au—Fe₂O₃—TiO₂, Pt—Ru—Fe₂O₃—TiO₂, Pd—Rh—Fe₂O₃—TiO₂, Pt—Ir—Fe₂O₃—TiO₂, Pd—Au—Fe₂O₃—TiO₂, Pd—Ru—Fe₂O₃—TiO₂, MnO₂—Fe₂O₃—TiO₂, Pt—MnO₂—Fe₂O₃—TiO₂, Pd—MnO₂—Fe₂O₃—TiO₂, Pt—Pd—MnO₂—Fe₂O₃—TiO₂, Pt—MnO₂—CeO₂—Fe₂O₃—TiO₂, Pd—MnO₂—CeO₂—Fe₂O₃—TiO₂, Pt—CeO₂—Fe₂O₃—TiO₂, Pd—CeO₂—Fe₂O₃—TiO₂, Ru—CeO₂—Fe₂O₃—TiO₂ and the like are exemplified, however, these combination examples are only for illustration purpose of generally stable oxides as elements other than noble metals, and metals as noble metals, and thus combinations of catalytic active constituents of the present invention should by no means limited thereto.

Content ratio of the catalytic active constituents and the carrier which supports the catalytic active constituent, which constitute the catalyst of the present invention, is not especially limited, however, in the case where the catalytic active constituents are noble metals (for example, platinum, palladium, rhodium, ruthenium, iridium, gold and silver), it is desirable that the active constituents are preferably contained in an amount of equal to or more than 0.01% by mass, more preferably equal to or more than 0.05% by mass, further preferably equal to or more than 0.1% by mass; preferably equal to or less than 3% by mass, more preferably equal toor less than 2% bymass, further preferably equal to or less than 1% by mass, relative to the carrier, in view of catalytic activity and durability of the catalyst.

In addition, in the case where the catalytic active constituents are other than noble metals (transition metals) (for example, manganese, cobalt, nickel, cerium, tungsten, and copper), it is preferable that the active constituent is preferably contained in an amount of equal to or more than 0.1% by mass, more preferably equal to or more than 0.5% by mass, further preferably equal to or more than 1% by mass; preferably equal to or less than 30% by mass, more preferably equal to or less than 20% by mass, further preferably equal to or less than 10% by mass, relative to the carrier, in view of catalytic activity and durability of the catalyst.

For example, in the case where the catalyst is Pt—TiO₂, ratio of Pt is desirably equal to or more than 0.01% by mass and equal to or less than 3% by mass. In addition, in the case where the catalyst is MnO₂—TiO₂, ratio of MnO₂ is desirably equal to or more than 0.1% by mass and equal to or less than 30% by mass.

In addition, in the case where a noble metal is used as the catalytic active constituent, the noble metal is preferably calculated as a metal for content ratio thereof. Also, in the case where the catalytic active constituent is other than the noble metal, a generally stable oxide is used as the catalytic active constituent, and content ratio of the oxide is preferably calculated. Furthermore, in the case where a plurality of the catalytic active constituents is contained, the catalyst preferably contains each of the catalytic active constituents within the above ratio.

The catalyst constituent of the present invention is not limited to the above examples, and other element or a compound may arbitrary be contained in combination, for example, an alkali metal, an alkaline earth metal, and other transition metal may also be contained.

The carrier of the present invention is required to have a solid acid amount of equal to or more than 0.20 mmol/g, and such a carrier results in to have excellent catalytic activity and durability. The solid acid amount below 0.20 mmol/g may sometimes not provide sufficient catalytic activity. The solid acid amount of the carrier of the present invention is preferably equal to or more than 0.22 mmol/l, more preferably equal to or more than 0.25 mmol/l, further preferably equal to or more than 0.27 mmol/l, and particularly preferably equal to or more than 0.30 mmol/l.

The catalytic activity is enhanced with increase in the solid acid amount of the carrier, however, too more solid acid amount may reduce the catalytic activity by contraries. Therefore, the solid acid amount is preferably equal to or less than 1.0 mmol/g, more preferably equal to or less than 0.8 mmol/g, further preferably equal to or less than 0.6 mmol/g, and particularly preferably equal to or less than 0.5 mmol/g.

In this way, by presence of more acid sites at the catalyst surface, chemical adsorption of pollutants in wastewater becomes easy, and further the adsorbed pollutants can be activated by electronic interaction, which largely promotes a decomposition reaction of the pollutants.

In addition, as a method for measuring the solid acid amount of the carrier in the present invention, a method for ammonia adsorption temperature-programmed desorption is adopted. This method is a general technique among those skilled in the art, and is carried out, for example, as follows: a carrier is dried in advance to measure weight thereof, then ammonia is passed through the carrier and temperature is raised to measure ammonia discharged; specifically includes a method, for example, by TPD (a temperature-programmed desorption method), for passing and adsorbing ammonia gas till saturation, under atmosphere at 50 to 120° C., onto the carrier which was dried in advance at 120 to 300° C. for 1 to 4 hours, and then raising temperature up to 500 to 700° C. to measure amount of ammonia desorbed from the carrier, or the like.

Preferable specific surface area of the catalyst is equal to or more than 20 m²/g. The specific surface area of the catalyst below 20 m²/g may provide insufficient catalytic activity; more preferably equal to or more than 25 m²/g and most preferably equal to or more than 30 m²/g. Also, the specific surface area of the catalyst over 70 m²/g may provide easy collapse of the catalyst and may also decrease catalytic activity. Therefore, preferable specific surface area is equal to or less than 70 m²/g, more preferably equal to or less than 60 m²/g, and most preferably equal to or less than 55 m²/g.

In the present invention, as a measurement method for specific surface area, a BET (Brunauer-Emett-Teller) method to analyze nitrogen adsorption is adopted.

As the catalyst relevant to the present invention, a single constituent catalyst may be used, however, depending on difference of constituents in wastewater, for example, treatment constituents in wastewater, pH or the like, a plurality of catalysts may also be used in combination as well. For example, the following embodiments are also possible; to treat wastewater using a plurality of catalysts obtainable by supporting different catalytic active constituents on the same carrier constituent; to treat wastewater using a plurality of catalysts obtainable by supporting the same catalytic active constituent on different carriers; to treat wastewater using a plurality of catalysts obtainable by supporting different catalytic active constituents on different carriers.

In particular, in the case where pH of wastewater is low, the wastewater may be treated with a catalyst having high treatment efficiency, after treatment with an acid resistant catalyst first; or in the case where pH of the wastewater is high, the wastewater may be treated with a catalyst having high treatment efficiency, after treatment with an alkali resistant catalyst, and so on.

Crystal structure of the carrier is not especially limited, and the carrier may have any of anatase-type crystal structure or crystal structure other than anatase-type crystal structure, however, the carrier having anatase-type crystal structure is preferable.

Shape of the catalyst (carrier) of the present invention may be selected, as appropriate, depending on objectives, from such as pellet-like, particle-like, spherical-like, ring-like, honeycomb-like or the like, and not especially limited.

Pore volume of the carrier is not especially limited, however, preferably equal to or larger than 0.20 ml/g, and more preferably equal to or larger than 0.25 ml/g are preferable; preferably equal to or smaller than 0.50 ml/g, and more preferably equal to or smaller than 0.45 ml/g. The pore volume below 0.20 ml/g is not capable of supporting the catalytic active constituent sufficiently on the carrier, which could reduce activated action. Also, the pore volume over 0.50 ml/g may sometimes reduce durability of the catalyst, resulting in collapse of the catalyst at an early stage, when the catalyst used in wet oxidation treatment. The pore diameter can be measured by a commercially available apparatus using a mercury injection method.

Catalyst size is not especially limited, however, for example, in the case where the catalyst is a particulate (hereafter may be referred to as “particulate catalyst”), average particle diameter is preferably equal to or larger than 1 mm, more preferably equal to or larger than 2 mm. Filling of the particulate catalyst with the average particle diameter below 1 mm, in a reaction tower, increases pressure loss and may clog a catalyst layer by suspended substances contained in wastewater. Also, the average particle diameter of the particulate catalyst is preferably equal to or smaller than 10 mm, and more preferably equal to or smaller than 7 mm. The average particle diameter over 10 mm inhibits for the particulate catalyst to have sufficient geometrical surface area, which may reduce contact efficiency with wastewater to be treated, and thus may not provide sufficient treatment capability in certain cases.

Also, for example, in the case where the catalyst is pellet-like (hereafter may be referred to as “pellet-like catalyst”), average diameter is preferably equal to or larger than 1 mm, more preferably equal to or larger than 2 mm; preferably equal to or smaller than 10 mm, and more preferably equal to or smaller than 6 mm. Also, length of the pellet-like catalyst in a longitudinal direction is preferably equal to or longer than 2 mm, and more preferably equal to or longer than 3 mm; preferably equal to or shorter than 15 mm, and more preferably equal to or shorter than 10 mm. Filling of the pellet-like catalyst with the average diameter below 1 mm, or the length in a longitudinal direction below 2 mm, in a reaction tower, increases pressure loss, while the pellet-like catalyst with the average diameter over 10 mm, or the length in a longitudinal direction over 15 mm inhibits for the particulate catalyst to have sufficient geometrical surface area, which may reduce contact efficiency with wastewater to be treated, and thus may not provide sufficient treatment capability in certain cases.

Furthermore, in the case where the catalyst is honeycomb-like (hereafter may be referred to as “honeycomb-like catalyst”), equivalent diameter of a through-hole is preferably equal to or larger than 1.5 mm, more preferably equal to or larger than 2.5 mm; preferably equal to or smaller than 10 mm, and more preferably equal to or smaller than 6 mm. In addition, thickness between the adjacent through-holes is preferably equal to or larger than 0.1 mm, more preferably equal to or larger than 0.5 mm; preferably equal to or smaller than 3 mm, and more preferably equal to or smaller than 2.5 mm. Furthermore, hole opening ratio at the catalyst surface is preferably equal to or more than 50%, more preferably equal to ormore than 55%; preferably equal to or less than 90%, and more preferably equal to or less than 85%, relative to total surface area. Filling the honeycomb-like catalyst with the equivalent diameter below 1.5 mm, in a reaction tower, increases pressure loss, while filling the honeycomb-like catalyst with the equivalent diameter over 10 mm may reduce contact efficiency with waste water to be treated and thus may reduce catalytic activity, although pressure loss becomes small. The honeycomb-like catalyst with the thickness between the through-holes below 0.1 mm may sometimes reduce mechanical strength of the catalyst, although providing advantage of being capable of reducing weight of the catalyst. Also, the thickness over 3 mm, although having sufficient mechanical strength of the honeycomb-like catalyst, increases use amount of catalyst raw material, and thus increases cost therewith. The hole opening ratio at the catalyst surface is also desirable to be set within the above range, in view of mechanical strength of the catalyst and catalytic activity.

In addition, use of the honeycomb-like catalyst is particularly recommended among the above catalysts, in the case of subjecting wastewater containing suspended substances to wet oxidation treatment, by filling the catalyst in a reaction tower, because a catalyst layer may be clogged by precipitates of solid substances or suspended substances and the like in wastewater.

A method for preparation of the catalyst relevant to the present invention is not especially limited, and the catalyst can easily be prepared by well-known methods. A method for supporting the catalyst active constituent on a carrier includes, for example, a kneading method, an impregnation method, an adsorption method, a spraying method, an ion exchange method or the like.

The catalyst having the above-described configuration is capable of maintaining catalytic activity and durability of the catalyst for a long period moreover, high mechanical strength can be provided. Also, treatment of wastewater by wet oxidation treatment, using the catalyst of the present invention as described above, is capable of providing treated water purified in high level.

Wet oxidation treatment of wastewater using the catalyst of the present invention will be explained in detail below. A kind of wastewater to be treated by wet oxidation treatment of the present invention is not especially limited, as long as being wastewater containing an organic compound and/or a nitrogen compound. Such wastewater is exemplified by wastewater discharged from various industrial plants including a chemical plant, electronics parts production equipment, food processing equipment, metal processing equipment, metal plating equipment, printing plate making equipment, photograph equipment and the like; power generation equipment such as thermal power generation or atomic power generation; and the like; specifically, wastewater discharged from EOG production equipment, production equipment of alcohols such as methanol, ethanol, higher alcohols and the like; in particular, wastewater containing organic substances discharged from a production process of an aliphatic acid and an ester thereof such as acrylic acid, acrylate, methacrylic acid, or methacrylate; or an aromatic carboxylic acid or an aromatic carboxylate ester such as terephthalic acid, or terephthalate ester. Also, wastewater containing a nitrogen compound such as amine or imine, ammonia, hydrazine or the like may also be included. Also, wastewater containing a sulfur compound discharged from plants in wide-ranging industrial fields such as pulp/paper, fiber, steel, ethylene/BTX, coal gasification, meat, chemical and the like may also be included. A sulfur compound here is exemplified by an inorganic sulfur compound such as hydrogen sulfide, sodium sulfide, potassium sulfide, sodium hydrosulfide, thiosulfate, sulfite and the like; or organic sulfur compounds such as mercaptans, sulfonic acids and the like. Also, for example, domestic wastewater such as sewage or human waste and the like may also be included. Or, wastewater containing toxic substances such as organic halogen compounds and endocrine disrupter compounds such as dioxins, frons, diethylhexyl phthalate, nonylphenol and the like may also be included.

In addition, “wastewater” in the present invention is not limited to so-called industrial wastewater discharged from the above various industrial plants, but, basically, all of liquid containing an organic compound and/or a nitrogen compound are included, and a supply source of such liquid is not especially limited.

Also, the catalyst of the present invention is used in wet oxidation treatment, and is recommended to be used in catalytic wet oxidation treatment, in particular, by heating wastewater and under pressure to maintain the wastewater in liquid phase.

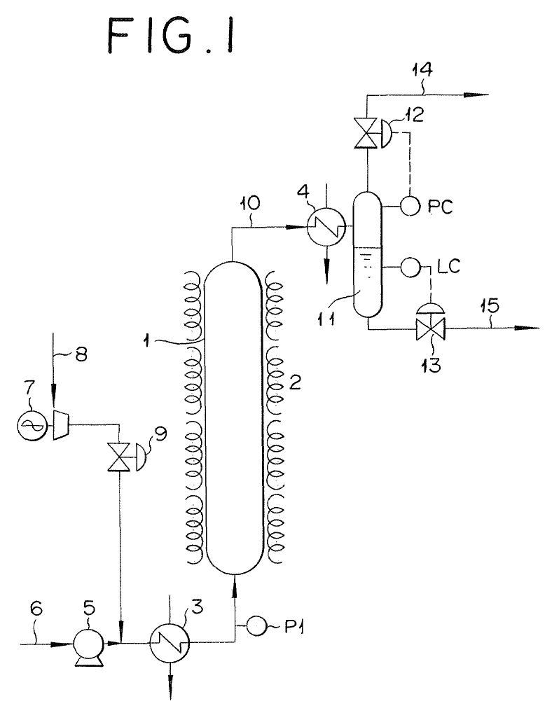

A method for treatment of wastewater will be explained below using a treatment apparatus shown in FIG. 1. FIG. 1 is a schematic view showing one embodiment of a treatment apparatus, in the case where wet oxidation treatment is adopted as one oxidation treatment step, however, an apparatus used in the present invention is by no means limited thereto.

Wastewater supplied from a wastewater supply source is supplied to the wastewater supply pump 5 through the wastewater supply line 6, and further sent to the heating unit 3. In this case, space velocity is not especially limited, and may be determined as appropriate, depending on treatment capability of a catalyst.

In the case where the catalyst of the present invention is used, wet oxidation treatment may be carried out under condition of either in the presence or absence of molecular oxygen-containing gas (hereafter may be referred to simply as oxygen-containing gas), however, mixing of oxygen-containing gas in wastewater is desirable, because increasing oxygen concentration in wastewater improves oxidative decomposition efficiency of substances to be oxidized contained in wastewater.

In the case where wet oxidation treatment is carried out in the presence of oxygen-containing gas, for example, it is desirable that oxygen-containing gas is introduced from the oxygen-containing gas supply line 8, and after pressure is increased by the compressor 7, oxygen-containing gas is mixed in wastewater before wastewater is supplied to the heating unit 3.

Oxygen-containing gas in the present invention represents gas containing oxygen molecules and/or ozone, and, as long as it is such a gas, the source may be any of pure oxygen, oxygen enriched gas, air, hydrogen peroxide water and oxygen-containing gas generated at other plants, and thus kind of oxygen-containing gas is not especially limited, however, use of air is recommended from economical viewpoint.

Supply amount, in the case where molecular oxygen-containing gas is supplied to wastewater, is not especially limited, as long as effective amount is supplied to enhance capability of oxidative decomposition of substances to be oxidized in wastewater. Supply amount of molecular oxygen-containing gas to wastewater may be adjusted, as appropriate, for example, by providing the oxygen-containing gas flow amount control valve 9 on the oxygen-containing gas supply line 8. It is recommended that supply amount of oxygen-containing gas is preferably equal to or higher than 0.5 time, more preferably equal to or higher than 0.7 time; preferably equal to or lower than 5.0 times, more preferably equal to or lower than 3.0 times of theoretical oxygen demand of substances to be oxidized in wastewater. Supply amount of oxygen-containing gas below 0.5 times may leave relatively much amount of substances to be oxidized in the resultant treated liquid via wet oxidation treatment, without sufficient oxidative decomposition treatment. In addition, oxygen supply even over 5.0 times may provide saturation of capability of oxidative decomposition treatment.

In addition, “theoretical oxygen demand” in the present invention represents oxygen amount necessary to oxidize and/or decompose substances to be oxidized in wastewater, to nitrogen, carbondioxide, water, or ash, and in the present invention, theoretical oxygen demand is represented by chemical oxygen demand (COD (Cr)). A measurement method for COD (Cr) is based on oxygen consumption amount by potassium dichromate, in accordance with JIS K 0102, 20.

Wastewater sent to the heating unit 3 is preheated, and then supplied to the reaction tower 1 equipped with the heating unit 2 (for example, an electric heater). Wastewater heated too high becomes gas state in the reaction tower, which may incur adhesion of organic substances at the catalyst surface, and may deteriorate catalyst activity. Therefore, pressurization inside the reaction tower is recommended, so that wastewater is capable of maintaining liquid phase even at high temperature. Also, temperature of wastewater in the reaction tower over 370° C. requires the application of high pressure to maintain wastewater in liquid phase, although depending on other conditions, which may require large scale equipment and may hike running cost; therefore, it is desirable that temperature of wastewater in the reaction tower is more preferably equal to or lower than 270° C., further preferably equal to or lower than 230° C., and further more preferably equal to or lower than 170° C. On the other hand, temperature of wastewater below 80° C. makes difficult efficient oxidative decomposition treatment of substances to be oxidized in wastewater; therefore, it is desirable that temperature of wastewater in the reaction tower is preferably equal to or higher than 80° C., more preferably equal to or higher than 100° C., and further preferably not lower than 110° C.

In addition, heating timing of wastewater is not especially limited, and as above-described, preheated wastewater may be supplied inside the reaction tower, or wastewater may be heated after being supplied inside the reaction tower. Also, a heating method for wastewater is not especially limited, and a heating unit or a heat exchanger may be used, or wastewater may be heated by installment of a heater inside the reaction tower. Furthermore, a heat source like steam or the like may be supplied to wastewater.

In addition, as will be described later, it is desirable that pressure is controlled as appropriate depending on treatment temperature by installment of the pressure control valve 12 at the exit side of exhaust gas of a wet oxidation treatment apparatus, so that wastewater is capable of maintaining liquid phase in the reaction tower 1. For example, in the case where treatment temperature is equal to or higher than 80° C. and below 95° C., wastewater is maintained in liquid phase even under atmospheric pressure, and thus treatment may be carried out under atmospheric pressure from economic viewpoint, however, pressurization is preferable to improve treatment efficiency. Also, in the case where treatment temperature is equal to or higher than 95° C., wastewater is vaporized under atmospheric pressure in many cases, therefore, pressurization as follows is preferable to control pressure so that wastewater is capable of maintaining liquid phase: a pressure of about 0.2 to 1 MPa (Gauge) for the case of treatment temperature of equal to or higher than 95° C., and below 170° C.; a pressure of about 1 to 5 MPa (Gauge) for the case of treatment temperature of equal to or higher than 170° C., and below 230° C.; or a pressure of over 5 MPa (Gauge) for the case of treatment temperature of equal to or higher than 230° C.

In addition, in wet oxidation treatment used in the present invention, number, kind, shape or the like of the reaction tower is not especially limited, and a reaction tower usually used in wet oxidation treatment may be used alone or by a combination of a plurality of reaction towers; for example, a single-tube type reaction tower or a multiple-tube type reaction tower may be used. Also, in the case where a plurality of reaction towers are used, the reaction towers may be arranged in an arbitrary manner such as in series or in parallel, depending on objectives.

As a method for supplying wastewater to the reaction tower, various embodiments may be used, including gas-liquid upward concurrent flow, gas-liquid downward concurrent flow, gas-liquid countercurrent flow and the like; also, in the case where a plurality of reaction towers are installed, 2 or more of these supply methods may be combined.

Use of the above-described solid catalyst, for wet oxidation treatment in a reaction tower, is capable of not only improving efficiency of oxidative decomposition treatment of substances to be oxidized such as organic compounds and/or nitrogen compounds included in wastewater, but also maintaining catalytic activity and catalyst durability for a long period, and thus converting wastewater as treated water purified in high level.

Amount of the catalyst to be filled in the reaction tower is not especially limited, and may be determined depending on objectives; usually, it is recommended that the filling amount of the catalyst is adjusted, so that space velocity per catalyst layer becomes 0.1 to 10 hr⁻¹, more preferably 0.2 to 5 hr⁻¹, and further preferably 0.3 to 3 hr⁻¹. Space velocity below 0.1 hr⁻¹ reduces treatment amount of the catalyst and thus requires large apparatus, while space velocity over 10 hr⁻¹ may provide insufficient oxidative decomposition treatment of wastewater in the reaction tower.

In the case where a plurality of the reaction towers are used, a different catalyst may be used for each tower, or a tower filled with the catalyst and a tower not filled with the catalyst may also be combined, and thus a use method for the catalyst of the present invention is not especially limited.

The shape of the catalyst to be filled is not especially limited, however, use of a honeycomb-like catalyst is desirable.

Also, various packing substances, internal products and the like may be incorporated in the reaction tower, aiming at stirring of gas-liquid, improvement of contact efficiency, reduction of drift of gas-liquid or the like.

Substances to be oxidized in wastewater is subjected to oxidative decomposition treatment in the reaction tower, and “oxidative decomposition treatment” in the present invention is exemplified by oxidative decomposition treatment which decomposes acetic acid into carbon dioxide and water; decarboxylation decomposition treatment which decomposes acetic acid into carbon dioxide and methane; oxidation or oxidative decomposition treatment which decompose dimethylsulfoxide into carbon dioxide, water, ash like sulfate ion; hydrolysis treatment which decomposes urea into ammonia and carbon dioxide; oxidative decomposition treatment which decomposes ammonia or hydrazine into nitrogen gas and water; oxidation treatment which oxidizes dimethylsulfoxide into dimethylsulfone or methane sulfonic acid or the like; namely, it represents various oxidations and/or decompositions such as decomposition treatment of easy-to-decompose substances to be oxidized, to nitrogen gas, carbon dioxide, water, ash, or the like; and decomposition treatment of difficult-to-decompose organic compounds or nitrogen compounds to lower molecular weight.

In addition, difficult-to-decompose organic compounds among substances to be oxidized are left as converted to low molecular weight substances, in the resultant treated liquid via wet oxidation treatment in many cases, and as organic compounds converted to low molecular weight substances, low molecular weight organic acids, in particular acetic acid are left in many cases.

Wastewater is subjected to oxidative decomposition treatment in the reaction tower 1, then taken out as treated liquid from the treated liquid line 10, and suitably cooled by the cooling unit 4, if necessary, and subsequently sent to the gas-liquid separation unit 11, to be separated into gas and liquid. In this case, it is desirable that liquid surface state is detected by the liquid level controller LC, and liquid level in the gas-liquid separation unit is controlled by the liquid level control valve 13, so as to be maintained constant. Also, it is desirable that pressure state is detected using the pressure controller PC, and pressure in the gas-liquid separation unit is controlled by the pressure control valve 12 so as to be maintained constant.

Here, temperature in the gas-liquid separation unit is not especially limited, however, it is desirable that, because carbon dioxide is contained in the resultant liquid by oxidative decomposition treatment in the reaction tower, for example, carbon dioxide in wastewater is discharged by raising temperature in the gas-liquid separation unit; or carbon dioxide in liquid is discharged by subjecting liquid, after separation using the gas-liquid separation unit, to bubbling with gas like air or the like.

Temperature of treated liquid may be controlled either by cooling the treated liquid before being supplied to the gas-liquid separation unit 11 by a heat exchanger (not shown), the cooling unit 4 or the like; or by cooling the treated liquid after gas-liquid separation, by installment of a cooling unit such as a heat exchanger (not shown), or a cooling unit (not shown) or the like.

Liquid (treated liquid) obtained by separation using the gas-liquid separation unit 11 is discharged from the treated liquid discharge line 15. The discharged liquid may further be subjected to various well-known steps such as biological treatment or membrane separation treatment, for further purification treatment. Furthermore, a part of the treated liquid obtained via wet oxidation treatment may directly be returned to wastewater before subjecting to wet oxidation treatment; or subjected to wet oxidation treatment by supplying to wastewater from the arbitrary position of the treated liquid discharge line. For example, TOD concentration or COD concentration of wastewater may be lowered by using the treated liquid, obtained via wet oxidation treatment, as dilution water.

Also, gas obtained by separation using the gas-liquid separation unit 1 1is discharged outside from the gas discharge line 14. In addition, the discharged gas may further be subjected to other steps.

In addition, in carrying out wet oxidation treatment used in the present invention, a heat exchanger may also be used as a heating unit or a cooling unit, and these units may be used in combination, as appropriate.

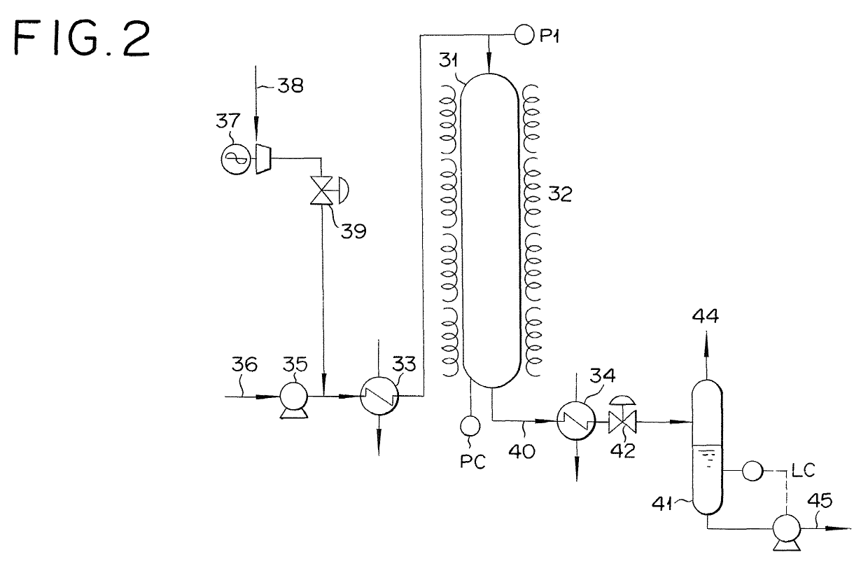

FIG. 2 is other embodiment of a treatment apparatus for wet oxidation treatment relevant to the present invention. In FIG. 2, in the similar treatment apparatus as shown in FIG. 1, wastewater mixed with oxygen-containing gas, if necessary, is supplied to the top of the reaction tower 31 through the wastewater supply line 36, contacted with a catalyst (not shown) filled in the reaction tower 31, and then sent to the gas-liquid fractionation tower 41 from the bottom of the tower via the treated liquid line 40, the cooling unit 34 and the pressure control valve 42, where it may also be separated to gas and liquid. In addition, in FIG. 2, the same reference numerals as in FIG. 1 but added with 30, represent the same parts.

The present invention will be explained in further detail below with reference to Examples, however, the Examples below should not limit the present invention, and modifications can be carried out without departing from the spirit of the description above or hereafter.

The present invention will be explained in more specifically below with reference to Catalyst Preparation Examples, Comparative Preparation Examples, Examples and Comparative Examples, however, the present invention is by no means limited thereto. A method for measurement of solid acid content in Preparation Examples and Comparative Preparation Examples will be shown below.

### <Measurement of Solid Acid Amount>

Solid acid amount was determined by a gaseous state base adsorption method. Ammonia was used as the gaseous state base.
Analysis apparatus: BEL-CAT, a catalyst analysis apparatus manufactured by BEL JAPAN, INC.
Analysis method: A TPD method (Temperature programing desorption Method)
Carrier gas: Helium
Detector: TCD (Thermal conduction type detector)
Pretreatment temperature/time: 200° C.×2 hours
Ammonia adsorption temperature: 100° C.
Temperature raising range: 100° C.→700° C.
Temperature raising speed: 10° C./min.

### CATALYST PREPARATION EXAMPLE 1

In catalyst preparation, a pellet-likely formed titania carrier was used. The carrier had an average diameter of 5 mm, an average length of 7.5 mm, an average compression strength (average value of load when the carrier (catalyst) fractured, adding a load on to the carrier (catalyst),) of 3.4 kg/particle, a specific surface area by a BET method of 44 m²/g, a solid acid amount of 0.32 mmol/g; titania crystal structure of the formed carrier was an anatase type. The catalyst (A-1) was obtained by a method for impregnating an aqueous solution of the catalytic active constituent in the carrier (the aqueous solution was absorbed by the addition of an aqueous solution of platinum nitrate, then dried at 150° C., and further subjected to firing treatment at 300° C. for 2 hours using hydrogen-containing gas). Major components of the resultant catalyst (A-1) and mass ratio thereof are as shown in Table 1. In addition, specific surface area, average compression strength, solid acid amount and titania crystal structure of the catalyst were nearly the same as those of the carrier used.

### CATALYST PREPARATION EXAMPLES 2 TO 7

In any of Catalyst Preparation Examples 2 to 7, the carrier used in Catalyst Preparation Example 1 was used. In a method for impregnating an aqueous solution of the catalytic active constituent in the carrier, the Catalysts (A-2 to A-7) listed in Table 1 were prepared by the same method as in Catalyst Preparation Example 1, except that a part of raw material was changed.

### CATALYST PREPARATION EXAMPLE 2 (A-2)

An aqueous solution of ruthenium nitrate was used as a catalytic active constituent.

### CATALYST PREPARATION EXAMPLE 3 (A-3)

An aqueous solution of palladium nitrate was used as a catalytic active constituent.

### CATALYST PREPARATION EXAMPLE 4 (A-4)

An aqueous solution of platinum nitrate and an aqueous solution of chloroiridium were used as catalytic active constituents.

### CATALYST PREPARATION EXAMPLE 5 (A-5)

An aqueous solution of platinum nitrate and an aqueous solution of rhodium nitrate were used as catalytic active constituents.

### CATALYST PREPARATION EXAMPLE 6 (A-6)

An aqueous solution of chloroauric acid and an aqueous solution of platinum nitrate were used as catalytic active constituents.

### CATALYST PREPARATION EXAMPLE 7 (A-7)

An aqueous solution of manganese nitrate was used as a catalytic active constituent to carry out firing treatment under air atmosphere.

Major components of the resultant catalysts (A-2 to A-7) and mass ratio thereof are as shown in Table 1. In addition, specific surface area, average compression strength, solid acid amount and titania crystal structure of the catalysts were nearly the same as those of the carrier used.

### COMPARATIVE PREPARATION EXAMPLE 1

In Comparative Preparation Example 1, a pellet-likely formed titania carrier was used. The carrier had an average diameter of 5 mm, an average length of 7.5 mm, an average compression strength of 3.1 kg/particle, a specific surface area by a BET method of 210 m²/g, a solid acid amount of 0.16 mmol/g; and titania crystal structure of the formed carrier was an anatase type. The Comparative Preparation Example 1 (A-8) was obtained by a method for impregnating an aqueous solution of the catalytic active constituent, similar to Catalyst Preparation Example 1, to the carrier (In addition, the aqueous solution of palladium nitrate was used as the catalytic active constitution). Major components of the resultant catalyst and mass ratio thereof are as shown in Table 1. In addition, specific surface area, average compression strength, solid acid amount and titania crystal structure of the catalyst were nearly the same as those of the carrier used.

### COMPARATIVE PREPARATION EXAMPLE 2

In Comparative Preparation Example 2, a pellet-likely formed titania carrier was used. The carrier had an average diameter of 5 mm, an average length of 7.5 mm, an average compression strength of 8.9 kg/particle, a specific surface area by a BET method of 0.54 m²/g, a solid acid amount of 0.19 mmol/g; titania crystal structure of the formed carrier was mainly a rutile type, containing certain portion of an anatase type. The Comparative Preparation Example 2 (A-9) was obtained by a method for impregnating an aqueous solution of the catalytic active constituent, similar to Catalyst Preparation Example 1, in the carrier (the aqueous solution of platinum nitrate was used as the catalytic active constitution). Major components of the resultant catalyst and mass ratio thereof are as shown in Table 1. In addition, specific surface area, average compression strength, solid acid amount and titania crystal structure of the catalyst were nearly the same as those of the carrier used.

### COMPARATIVE PREPARATION EXAMPLE 3

In Comparative Preparation Example 3, a pellet-likely formed titania carrier was used. The carrier had an average diameter of 5 mm, an average length of 7.5 mm, an average compression strength of 1.1 kg/particle, a specific surface area by a BET method of 12 m²/g, a solid acid amount of 0.17 mmol/g; titania crystal structure of the formed carrier was mainly an anatase type, containing certain portion of a rutile type. The Comparative Preparation Example 3 (A-10) was obtained by a method for impregnating an aqueous solution of the catalytic active constituent, similar to Catalyst Preparation Example 1, in the carrier (In addition, the aqueous solution of ruthenium nitrate was used as the catalytic active constitution). Major components of the resultant catalyst and mass ratio thereof are as shown in Table 1. In addition, specific surface area, average compression strength, solid acid amount and titania crystal structure of the catalyst were nearly the same as those of the carrier used.

TABLE 1

| | Catalyst | Main components and |
|---|---|---|
| | name | mass ratio |
| Cat. Prep. Expl. 1 | A-1 | TiO₂:Pt = 100:0.2 |
| Cat. Prep. Expl. 2 | A-2 | TiO₂:Ru = 100:1 |
| Cat. Prep. Expl. 3 | A-3 | TiO₂:Pd = 100:0.5 |
| Cat. Prep. Expl. 4 | A-4 | TiO₂:Pt:Ir = 100:0.2:0.3 |
| Cat. Prep. Expl. 5 | A-5 | TiO₂:Pt:Rh = 100:0.2:0.4 |
| Cat. Prep. Expl. 6 | A-6 | TiO₂:Au:Pt = 100:0.2:0.2 |
| Cat. Prep. Expl. 7 | A-7 | TiO₂:MnO₂ = 100:2.5 |
| Comp. Prep. Expl. 1 | A-8 | TiO₂:Pd = 100:0.5 |
| Comp. Prep. Expl. 2 | A-9 | TiO₂:Pt = 100:0.2 |
| Comp. Prep. Expl. 3 | A-10 | TiO₂:Ru = 100:1 |

(Note)
Cat. Prep. Expl.: Catalyst Preparation Example
Comp. Prep. Expl.: Comparative Preparation Example

### CATALYST PREPARATION EXAMPLES 8 TO 11

In Catalyst Preparation Examples 8 to 11, a pellet-likely formed carrier containing titanium oxide, along with a composite oxide of titanium and zirconium were used. The carrier had an average diameter of 4 mm, an average length of 5 mm, an average compression strength of 3.9 kg/particle, a specific surface area by a BET method of 47 m²/g, a solid acid amount of 0.34 mmol/g; crystal structure of titanium oxide contained in the formed carrier was an anatase type. And the Catalyst Preparation Example 8 (B-1), the Catalyst Preparation Example 9 (B-2), the Catalyst Preparation Example 10 (B-3), and the Catalyst Preparation Example 11 (B-4) were each obtained by a method for impregnating an aqueous solution of the catalytic active constituent, similar to Catalyst Preparation Example 1, in the carrier (in addition, the aqueous solution platinum nitrate as the catalytic active constituent in Catalyst Preparation Example 8, the aqueous solution ruthenium nitrate as the catalytic active constituent in Catalyst Preparation Example 9, the aqueous solution palladium nitrate as the catalytic active constituent in Catalyst Preparation Example 10, and the aqueous solution manganese nitrate as the catalytic active constituent in Catalyst Preparation Example 11 were used). Major components of the resultant catalysts (B-1 to B-4) and mass ratio thereof are as shown in Table 2. In addition, specific surface area, average compression strength, solid acid amount and titania crystal structure of the catalyst were nearly the same as those of the carrier used.

### COMPARATIVE PREPARATION EXAMPLE 4

In Comparative Preparation Example 4, a pellet-likely formed carrier containing titanium oxide, along with a composite oxide of titanium and zirconium were used. The carrier had an average diameter of 4 mm, an average length of 5 mm, an average compression strength of 6.5 kg/particle, a specific surface area by a BET method of 13 m²/g, a solid acid amount of 0.10 mmol/g; crystal structure of titanium oxide contained in the formed carrier was a mixture of a rutile type and an anatase type. The Comparative Preparation Example 4 (B-5) was obtained by a method for impregnating an aqueous solution of the catalytic active constituent to the carrier, a similar method as in Catalyst Preparation Example 1 (In addition, the aqueous solution of platinum nitrate was used as the catalytic active constitution). Major components of the resultant catalyst and mass ratio thereof are as shown in Table 2. In addition, specific surface area, average compression strength, solid acid amount and titania crystal structure of the catalyst were nearly the same as those of the carrier used.

TABLE 2

| | Catalyst | Main components and mass |
|---|---|---|
| | name | ratio |
| Cat. Prep. Expl. 8 | B-1 | TiO₂:ZrO₂:Pt = 80:20:0.2 |
| Cat. Prep. Expl. 9 | B-2 | TiO₂:ZrO₂:Ru = 80:20:0.8 |
| Cat. Prep. Expl. 10 | B-3 | TiO₂:ZrO₂:Pd = 80:20:0.4 |
| Cat. Prep. Expl. 11 | B-4 | TiO₂:ZrO₂:MnO₂ = 80:20:4 |
| Comp. Prep. Expl. 4 | B-5 | TiO₂:ZrO₂:Pt = 80:20:0.2 |

(Note)
Cat. Prep. Expl.: Catalyst Preparation Example
Comp. Prep. Expl.: Comparative Preparation Example

### CATALYST PREPARATION EXAMPLES 12 TO 15

In Catalyst Preparation Examples 12 to 15, a pellet-likely formed carrier containing titanium oxide, iron oxide, along with a composite oxide of titanium and iron were used. The carrier had an average diameter of 3 mm, an average length of 4 mm, an average compression strength of 3.1 kg/particle, a specific surface area by a BET method of 52 m²/g, a solid acid amount of 0.32 mmol/g; crystal structure of titanium oxide contained in the formed carrier was an anatase type. The Catalyst Preparation Example 12 (C-1), the Catalyst Preparation Example 13 (C-2), the Catalyst Preparation Example 14 (C-3), and the Catalyst Preparation Example 15 (C-4) were each obtained by a method for impregnating an aqueous solution of the catalytic active constituent, similar to Catalyst Preparation Example 1, in the carrier (In addition, the aqueous solution an aqueous solution of hexaammine platinum hydroxide as the catalytic active constituent in Catalyst Preparation Example 12, the aqueous solution an aqueous solution of potassium ruthenate as the catalytic active constituent in Catalyst Preparation Example 13, the aqueous solution an aqueous solution of palladium nitrate as the catalytic active constituent in Catalyst Preparation Example 14, and the aqueous solution an aqueous solution of manganese nitrate as the catalytic active constituent in Catalyst Preparation Example 15 were used). Major components of the resultant catalysts (C-1 to C-4)and mass ratio thereof are as shown in Table 3. In addition, specific surface area, average compression strength, solid acid amount and titania crystal structure of the catalyst were nearly the same as those of the carrier used.

### COMPARATIVE PREPARATION EXAMPLE 5

In Comparative Preparation Example 5, a pellet-likely formed carrier containing titanium oxide, iron oxide, along with a composite oxide of titanium and iron were used. The carrier had an average diameter of 3 mm, an average length of 4 mm, an average compression strength of 3.0 kg/particle, a specific surface area by a BET method of 97 m²/g, a solid acid amount of 0.12 mmol/g; crystal structure of titanium oxide contained in the formed carrier was an anatase type. The Comparative Preparation Example 5 (C-5) was obtained by a method for impregnating an aqueous solution of the catalytic active constituent, similar as in Catalyst Preparation Example 1, in the carrier (In addition, the aqueous solution of palladium nitrate was used as the catalytic active constitution). Major components of the resultant catalyst and mass ratio thereof are as shown in Table 3. In addition, specific surface area, average compression strength, solid acid amount and titania crystal structure of the catalyst were nearly the same as those of the carrier used.

TABLE 3

| | Catalyst | Main components and mass |
|---|---|---|
| | name | ratio |
| Cat. Prep. Expl. 12 | C-1 | TiO₂:Fe₂O₃:Pt = 50:50:0.2 |
| Cat. Prep. Expl. 13 | C-2 | TiO₂:Fe₂O₃:Ru = 80:20:0.9 |
| Cat. Prep. Expl. 14 | C-3 | TiO₂:Fe₂O₃:Pd = 80:20:0.5 |
| Cat. Prep. Expl. 15 | C-4 | TiO₂:Fe₂O₃:MnO₂ = 80:20:3 |
| Comp. Prep. Expl. 5 | C-5 | TiO₂:Fe₂O₃:Pd = 80:20:0.5 |

(Note)
Cat. Prep. Expl.: Catalyst Preparation Example
Comp. Prep. Expl.: Comparative Preparation Example

### EXAMPLE 1

Into an autoclave made of titanium having inner volume 1000-mL, equipped with a stirrer, 20 ml of the catalyst (A-1) and 200 mL of wastewater were charged, and air was introduced so that pressure became 2.4 MPa (Gauge). Then, temperature was raised up to 160° C. while stirring at a stirring speed of 200 rpm; after the temperature reached 160° C., treatment was carried out for 1.5 hours. In addition, treatment pressure was set to be 4.1 MPa (Gauge). After completion of the treatment, the autoclave was quenched to take out treated liquid. The wastewater used in the treatment was one discharged from production processes of aliphatic carboxylic acids and aliphatic carboxylate esters containing such as formic acid, formaldehyde and acetic acid, and (a COD (Cr) concentration was 22 g/liter). The resultant treatment results of wastewater are shown in Table 4.

### EXAMPLES 2 TO 7

The same wastewater was treated by the same method as in Example 1, except that the catalysts were changed each to A-2 to A-7. The results are shown in Table 4.

### COMPARATIVE EXAMPLES 1 TO 3

The same wastewater was treated by the same method as in Example 1, except that the catalysts were changed each to A-8 to A-10. The results are shown in Table 4.

TABLE 4

| | Catalyst | COD(Cr)treat. |
|---|---|---|
| | used | Efficiency |
| Example 1 | A-1 | 98% |
| Example 2 | A-2 | 90% |
| Example 3 | A-3 | 93% |
| Example 4 | A-4 | 98% |
| Example 5 | A-5 | 98% |
| Example 6 | A-6 | 98% |
| Example 7 | A-7 | 90% |
| Comp. Example 1 | A-8 | 83% |
| Comp. Example 2 | A-9 | 67% |
| Comp. Example 3 | A-10 | 50% |

(Note)
Comp. Example: Comparative Example

### EXAMPLE 8

Treatment was carried out for 200 hours under the conditions described below, using an apparatus as shown in FIG. 1. Inside the reaction tower 1 (a cylindrical one with a diameter of 26 mm, and a length of 3000 mm), 1.0 liter of the catalyst (B-1) was filled. Wastewater subjected to the treatment was one discharged from a chemical plant, and contained a solvent-type organic compound. In addition, COD (Cr) of the wastewater was 14 g/liter.

The wastewater was supplied to the wastewater supply pump 5 through the wastewater supply line 6, and after being fed under increasing pressure in a flow rate of 2.0 liter/hr, heated up to 230° C. by the heating unit 3, and supplied to the reaction tower 1 from the bottom thereof. Also, air was supplied from the oxygen-containing gas supply line 8, and after pressure was raised by the compressor 7, air was mixed into the wastewater at the position before the heating unit 3, under control of flow rate by the oxygen-containing gas flow amount control valve 9, so that O₂/COD (Cr) (oxygen amount in supply gas/chemical oxygen demand of wastewater) became 2.0. In addition, in the reaction tower 1, the treatment was carried out in gas-liquid upward concurrent flow. In the reaction tower 1, temperature of the wastewater was maintained at 230° C. using the electric heater 2, to carry out oxidative decomposition treatment. The resultant treated liquid was sent to the gas-liquid separation unit 11 via the treated liquid line 10 for gas-liquid separation. In this case, liquid level was detected by the liquid level controller LC in the gas-liquid separation unit 11, and the treated liquid was discharged from the liquid level control valve 13, so that the liquid level was maintained constant. Also, the pressure control valve 12 detected pressure using pressure controller PC, and controlled the pressure so as to be maintained at 5 MPa (Gauge). The resultant treatment results of wastewater are shown in Table 5.

### EXAMPLES 9 TO 11 AND COMPARATIVE EXAMPLE 4

The same wastewater was treated by the same method as in Example 8, except that the catalysts were changed each to B-2 to B-5. The results are shown in Table 5.

TABLE 5

| | Catalyst | COD(Cr)treat. |
|---|---|---|
| | used | Efficiency |
| Example 8 | B-1 | 97% |
| Example 9 | B-2 | 91% |
| Example 10 | B-3 | 94% |
| Example 11 | B-4 | 90% |
| Comp. Example 4 | B-5 | 64% |

(Note)
Comp. Example: Comparative Example

### EXAMPLE 12

Treatment was carried out for 200 hours under the conditions described below, using an apparatus as shown in FIG. 2. Inside the reaction tower 31 (a cylindrical one with a diameter of 26 mm, and a length of 3000 mm), 1.0 liter of the catalyst (C-1) was filled. As wastewater subjected to the treatment, one containing a nonionic type polymer, a carboxylic acid and alcohols was used. Also, COD (Cr) of the wastewater was 16 g/liter.

The wastewater was supplied to the wastewater supply pump 35 through the wastewater supply line 36, and after being fed under increasing pressure in a flow rate of 1.0 liter/hr, heated up to 165° C. by the heating unit 33, and supplied to the reaction tower 31 from the bottom thereof. Also, air was supplied from the oxygen-containing gas supply line 38, and after pressure was raised by the compressor 37, air was mixed into the wastewater at the position before the heating unit 33, under control of flow rate by the oxygen-containing gas flow amount control valve 39, so that O₂/COD (Cr) (oxygen amount in supply gas/chemical oxygen demand of wastewater) became 0.9. In addition, the treatment was carried out in the reaction tower 31 in gas-liquid downward concurrent flow. In the reaction tower 31, temperature of the wastewater was maintained at 165° C. using the electric heater 32, to carry out oxidative decomposition treatment. The resultant treated liquid was cooled to 80° C. by the cooling unit 34 via the treated liquid line 40, and then depressurized and discharged from the pressure control valve 42. In addition, the pressure control valve 42 detected pressure using pressure controller PC, and controlled the pressure so as to be maintained at 0.9 MPa (Gauge). The discharged gas and liquid were sent to the gas-liquid separation unit 41 for separation of gas and liquid. The resultant treatment results of wastewater are shown in Table 6.

### EXAMPLES 13 TO 15 AND COMPARATIVE EXAMPLE 5

The same wastewater was treated by the same method as in Example 12, except that the catalysts were changed each to C-2 to C-5. The results are shown in Table 6.

TABLE 6

| | | COD(Cr) |
|---|---|---|
| | Catalyst | treat. |
| | used | Efficiency |
| Example 12 | C-1 | 86% |
| Example 13 | C-2 | 80% |
| Example 14 | C-3 | 81% |
| Example 15 | C-4 | 78% |
| Comp. Example 5 | C-5 | 66% |

(Note)
Comp. Example: Comparative Example

### EXAMPLE 16

Treatment was carried out for 200 hours under the conditions described below, using an apparatus as shown in FIG. 1. Inside the reaction tower 1 (a cylindrical one with a diameter of 26 mm, and a length of 3000 mm), 0.5 liter of the catalyst (C-2) was filled. Wastewater subjected to the treatment was one discharged from a chemical plant and has contained sodium sulfide, sodium thiosulfate or the like was used. In addition, COD (Cr) of the wastewater was 20 g/liter.

The wastewater was supplied to the wastewater supply pump 5 through the wastewater supply line 6, and after being fed under increasing pressure in a flow rate of 0.75 liter/hr, heated up to 165° C. by the heating unit 3, and supplied to the reaction tower 1 from the bottom thereof. In addition, air was supplied from the oxygen-containing gas supply line 8, and after pressure was raised by the compressor 7, air was mixed into the waste water at the position before the heating unit 3, under control of flow rate by the oxygen-containing gas flow amount control valve 9, so that O₂/COD (Cr) (oxygen amount in supply gas/chemical oxygen demand of wastewater) became 2.0. In addition, the treatment was carried out in the reaction tower 1 in gas-liquid upward concurrent flow. In the reaction tower 1, temperature of the wastewater was maintained at 165° C. using the electric heater 2, to carry out oxidative decomposition treatment. The resultant treated liquid was cooled to 50° C. by the cooling unit 4 via the treated liquid line 10, and then depressurized and discharged from the pressure control valve 12. In addition, the pressure control valve 12 detected pressure using pressure controller PC, and controlled the pressure so as to be maintained at 0.9 MPa (Gauge). The discharged gas and liquid were sent to the gas-liquid separation unit 11 for separation of gas and liquid. The resultant treatment results of wastewater are shown in Table 7.

### EXAMPLE 17 AND COMPARATIVE EXAMPLE 6

The same wastewater was treated by the same method as in Example 16, except that the catalysts were changed each to C-4 and C-5. The results are shown in Table 7.

TABLE 7

| | | COD(Cr) |
|---|---|---|
| | Catalyst | treat. |
| | used | Efficiency |
| Example 16 | C-2 | 88% |
| Example 17 | C-4 | 79% |
| Comp. Example 6 | C-5 | 51% |

(Note)
Comp. Example: Comparative Example

The entire disclosure of Japanese Patent Application No. 2006-065517 filed on Mar. 10, 2006 including specification, claims, drawings, and summary are incorporated herein by reference in its entirety.

1. A catalyst for wastewater treatment comprising a catalytic active constituent containing at least one kind of an element selected from the group consisting of manganese, cobalt, nickel, cerium, tungsten, copper, silver, gold, platinum, palladium, rhodium, ruthenium and iridium, or a compound thereof, and a carrier constituent containing at least one kind of an element selected from the group consisting of iron, titanium, silicon, aluminum and zirconium, or a compound thereof, characterized in that solid acid amount of said carrier constituent is equal to or more than 0.20 mmol/g.

2. The catalyst according to claim 1, wherein the solid acid amount of said carrier constituent is 0.20 to 1.0 mmol/g.

3. The catalyst according to claim 1, wherein a specific surface area of said catalyst is 20 to 70 m²/g.

4. The catalyst according to claim 1, wherein the catalytic active constituent is at least one kind of an element selected from the group consisting of manganese, cerium, gold, palladium, rhodium, ruthenium and iridium, or a compound thereof.

5. The catalyst according to claim 1, wherein the catalytic active constituent is at least one kind of an element selected from the group consisting of manganese, platinum, palladium, ruthenium and gold, and a compound thereof.

6. The catalyst according to claim 1, wherein the carrier constituent is a titanium oxide, or a mixture or a composite oxide between titanium oxide and an oxide of at least one kind of a metal selected from the group consisting of zirconium, iron, silicon and aluminum.

7. The catalyst according to claim 1, wherein the carrier constituent is a titanium oxide, or a mixture or a composite oxide between titanium oxide and an oxide of at least one kind of a metal selected from the group consisting of zirconium and iron.

8. The catalyst according to claim 1, wherein the amount of a noble metal-based catalytic active constituent is 0.01 to 3% by mass, relative to said carrier.

9. The catalyst according to claim 1, wherein the amount of a transition metal-based catalytic active constituent is 0.1 to 30% by mass, relative to said carrier.

10. The catalyst according to claim 1, wherein the solid acid amount of said carrier constituent is 0.22 to 0.8 mmol/g.

11. The catalyst according to claim 1, wherein the specific surface area of said catalyst is 25 to 60 m²/g.

12. A method for wastewater treatment comprising treatment of wastewater using the catalyst according to claim 1.

13. The method according to claim 12, wherein the treatment method for said wastewater is carried out by wet oxidation.
